(19) United States
(12) Patent Application Publication
(10) Pub. No.: US 2015/0084454 A1
(43) Pub. Date: Mar. 26, 2015

(54) POLE UNIT AND STATOR ASSEMBLY FOR A WIND TURBINE GENERATOR, AND METHODS OF MANUFACTURING THE SAME

(71) Applicant: SIEMENS AKTIENGESELLSCHAFT, 80333 MUNCHEN (DE)

(72) Inventor: BJARNE NOER, VIBORG (DK)

(21) Appl. No.: 14/493,387

(22) Filed: Sep. 23, 2014

(30) Foreign Application Priority Data
Sep. 26, 2013 (EP) 13186189.0

(51) Int. Cl. H02K 1/14; H02K 15/02; H02K 7/18; H02K 9/02

(52) U.S. Cl. CPC H02K 1/148; H02K 9/02; H02K 15/022; H02K 7/183
USPC 310/58; 29/596

(57) ABSTRACT

A pole unit for a stator assembly of a wind turbine generator, the pole unit including (a) a laminated body structure having a base portion, an intermediate portion, and a top portion, and (b) a coil wound around the intermediate portion, wherein (c) the intermediate portion extends from at least a part of an upper surface of the base portion, and wherein (d) the top portion extends from the end of the intermediate portion that is opposite to the base portion and has an increasing cross-section in the direction away from the intermediate portion is provided. A stator assembly including a plurality of pole units, a method of manufacturing a pole unit, and a method of assembling a stator assembly are also provided.

### CROSS-REFERENCE TO RELATED APPLICATIONS

This application claims priority to EP Application No. 13186189.0 having a filing date of Sep. 26, 2013, the entire contents of which are hereby incorporated by reference.

### FIELD OF TECHNOLOGY

The following relates to the field of wind turbine generators, in particular, to a pole unit for a stator assembly of a wind turbine generator and a method of manufacturing such a pole unit. The following further relates to a stator assembly for a wind turbine generator, a corresponding method of assembling such stator assembly, a wind turbine generator and a wind turbine.

### BACKGROUND

A wind turbine generator generally comprises a stator and a rotor, e.g. a stator comprising a plurality of coils and a rotor comprising a plurality of magnets. When the rotor rotates relative to the stator, electric current is induced in the coils.

Due to the significant size and weight of modern wind turbines, the stator can usually not be transported from the production plant in one piece. Instead, it is known to produce stator segments which can be fitted together to form the stator. More specifically, the stator segments are formed by welding stamped lamination with slots onto a rounded support structure corresponding to a part of a cylinder and fitting pre-manufactured coils (i.e. coils wound around a tubular material) into the stator slots. An exemplary stator may e.g. be built from three 120° segments, four 90°, six 60° or even twelve 30° segments each comprising a number of coils, such that the complete stator comprises a total of 82, 96, 108 or 142 coils. Although such segments can be transported, e.g. on special trucks, the transportation is still cumbersome and expensive, in particular due to the size and curved shape of the segments, which makes an efficient packing of the segments nearly impossible.

Apart from the transportation issue, the large stator segments suffer from a number of further drawbacks. First of all, it is very difficult to assemble the segments to a total stator, with the precision required to meet the tight tolerances relative to the rotor, i.e. to assure a small and uniform air gap between rotor and stator. Furthermore, due to the use of pre-manufactured coils, adjustment of the capacitance between coil and rotor necessitates addition of conductive material between coil and rotor after fitting of the coils.

Accordingly, there may be a need for an improved and simplified way of segmenting a stator for a wind turbine generator in order to overcome or at least reduce the disturbing impact of the above-mentioned and other drawbacks.

### SUMMARY

A first aspect relates to a pole unit for a stator assembly of a wind turbine generator, the pole unit comprising (a) a laminated body structure comprising a base portion, an intermediate portion, and a top portion, and (b) a coil wound around the intermediate portion, wherein (c) the intermediate portion extends from at least a part of an upper surface of the base portion, and wherein (d) the top portion extends from the end of the intermediate portion that is opposite to the base portion and has an increasing cross-section in the direction away from the intermediate portion.

The first aspect of the invention can be based on the idea that a compact single pole unit for a stator assembly is constructed as a high-precision laminated integral body structure comprising a base portion, an intermediate portion and a top portion, whereby the coil is wound directly around the intermediate portion. The increasing cross-section of the top section reduces the area of the coil surface that can be “seen” by a rotor and thereby reduces the capacitance between coil and rotor. The increasing cross-section may further assist in keeping the coil in position and reduce noise. The pole unit can be manufactured with high precision by stamping thin metal sheets and gluing them together to form the laminated body structure. Furthermore, the directly wound coil can be fit tightly to the body structure. The compact pole unit can be efficiently packed for storage and transportation.

In the present context, the term “laminated body structure” may in particular denote an integral structure formed by gluing metal sheets of varying shape and size together. The base portion of the laminated body structure may form a lower part of the pole unit. In other words, the base portion may be the part of the laminated body structure which is supposed to be arranged and fastened on a stator support structure during assembly of a stator. The intermediate portion of the laminated body structure may be the part of the laminated body structure that forms a metallic core for the coil of the pole unit. The top portion of the laminated body structure may form the head of the pole unit and may be the part of the pole unit that will be closest to a rotor when fitted in a generator.

According to embodiments of the invention, the base portion may have a substantially flat rectangular shape, the intermediate portion may have a substantially rectangular cross-sectional shape, and the cross-sectional area of the intermediate portion can be smaller than the area of the base portion.

In the present context, the term “rectangular” may in particular denote any shape with four pairwise parallel sides where all corners are about 90°. In other words, a quadratic shape is also considered to be a rectangular shape. Embodiments of the base portion may be substantially flat in the sense that the thickness of the base portion is small relative to the other two dimensions (width and depth) of the base portion. However, the thickness of the base portion can be sufficient to provide the necessary support and stability for the pole unit when the latter is mounted on a stator support structure. Embodiments of the intermediate portion may have a substantially rectangular cross-sectional shape and a cross-sectional area that can be smaller than the area of the base portion. In other words, the intermediate portion may extend as a beam from the base portion, such that a T-shaped structure is formed.

According to further embodiments of the invention, the base portion may comprise a recess, the recess being formed in a lower surface of the base portion. The recess can be formed in the lower surface of the base portion, i.e. on the surface of the base portion that is opposite to the intermediate portion. The recess may have an elongate shape and extend centrally from one side of the base portion to the opposing side of the base portion, i.e. across the entire lower surface of the base portion in one direction thereof The bottom of the recess may be parallel to the upper and lower surface of the base portion. The sides of the recess may be tilted such that the cross-section of the recess increases in the direction from the lower surface of the base portion towards the bottom of the recess. The recess may be formed during the lamination process or it may be cut out from the laminated structure.

According to further embodiments of the invention, the base portion may comprise at least one protrusion, the at least one protrusion being formed on the lower surface of the base portion. The at least one protrusion may be an integral part of the base portion, i.e. it is formed directly during the lamination process. The at least one protrusion may have a rectangular cross-sectional shape and extend in the vicinity of and parallel with one side of the base portion. The at least one protrusion may extend across the entire lower surface of the base portion. In embodiments comprising the above-mentioned recess, the at least one protrusion may extend in parallel with the recess. In the present embodiment, a further protrusion of similar shape and size may extend in the vicinity of and in parallel with the side of the base portion that is opposite to the above-mentioned one side of the base portion. In other words, the base portion may comprise two similar and parallel protrusions extending in the vicinity of opposite sides of the base portion.

According to further embodiments of the invention, the recess may be configured to engage with a fastening member, and/or the at least one protrusion may be configured to engage with a corresponding recess in a support structure. The recess may in particular be adapted to engage with a fastening member having a shape fitting that of the recess such that the pole unit can be pushed or slid onto the fastening member. The at least one protrusion may in particular be adapted to engage with a recess in a support structure, such that the pole unit can be guided towards a predetermined position relative to the support structure. In embodiments comprising both the recess and the at least one protrusion, the pole unit may be fastened to the support structure by means of at least one screw extending through the support structure and into the fastening member such that the fastening member—and thereby the pole unit—is pulled towards the support structure.

According to further embodiments of the invention, the base portion may comprise a side protrusion and a side recess, the side protrusion and the side recess being formed in opposing side surfaces of the base portion. The side protrusion and the side recess may have corresponding shapes, such that the side protrusion of one pole unit can engage with the side recess of a neighboring pole unit during assembly of a stator assembly. Thereby, correct positioning of the pole units and stability of the stator assembly can be facilitated.

According to further embodiments of the invention, the coil may comprise a flat electrically conductive wire material. In the present context, term “flat electrically conductive wire material” may in particular denote a band-shaped wire, i.e. a flat wire having a rectangular cross-sectional shape. The flat electrically conductive wire material may comprise copper or a similar metallic material with excellent electrical conductivity properties. By forming the coil from a flat wire material, a tight fit around the intermediate portion can be achieved.

According to a second aspect of the invention, there is provided a stator assembly for a wind turbine generator, the stator assembly comprising (a) a stator support structure, and (b) a plurality of pole units according to the first aspect or any of the above embodiments, wherein the pole units are arranged along a circumference of the stator support structure.

The second aspect of the invention can be based on the idea that a stator assembly is constructed by arranging a plurality of compact high-precision single pole units along the circumference of the stator support structure. Thereby, the pole units and the stator support structure can be transported efficiently and separate from one another to a suitable place, such as the place where a wind turbine is to be installed, and assembled. The stator support structure may be a cylindrical structure, which is maximizing the roundness of the stator structure.

According to a third aspect of the invention, there is provided a wind turbine generator comprising a stator assembly according to the second aspect. The wind turbine generator according to this aspect may be efficiently assembled at the place where a wind turbine is to be installed.

According to a fourth aspect of the invention, there is provided a wind turbine comprising a wind turbine generator according to the third aspect. The wind turbine according to this aspect may be efficiently assembled at the place of installation.

According to a fifth aspect of the invention, there is provided a method of manufacturing a pole unit for a stator assembly of a wind turbine generator, the method comprising (a) stamping and gluing a plurality of layers of sheet metal, thereby forming a laminated body structure comprising a base portion, an intermediate portion, and a top portion, wherein the intermediate portion extends from at least a part of an upper surface of the base portion, and wherein the top portion extends from the end of the intermediate portion that is opposite to the base portion and has an increasing cross-section in the direction away from the intermediate portion, and (b) winding a coil around the intermediate portion.

The fifth aspect of the invention can be based on the idea that a compact single pole unit for a stator assembly is manufactured as a high-precision laminated integral body structure comprising a base portion, an intermediate portion and a top portion, whereby the coil is wound directly around the intermediate portion. The increasing cross-section of the top section reduces the area of the coil surface that can be “seen” by a rotor and thereby reduces the capacitance between coil and rotor. The increasing cross-section may further assist in keeping the coil in position and reduce noise. The pole unit may be manufactured with high precision by stamping thin metal sheets and gluing them together to form the laminated body structure. Furthermore, the directly wound coil can be fit tightly to the body structure. The compact pole unit can be efficiently packed for storage and transportation. In the present context, the term “stamping” may particularly denote a process of cutting out a piece of sheet metal, said piece having a predetermined shape and size. In the present context, the term “gluing” may particularly denote a process of providing a layer of adhesive material to a surface of a first stamped piece of sheet metal, arranging a second stamped piece of sheet metal on top of the first stamped piece of sheet metal, and pressing the two stamped pieces of sheet material against each other. The step of stamping and gluing may be performed in such a manner, that each stamped layer of sheet material is glued onto the existing laminated body structure. In other words, the laminated body structure is formed by adding one layer at a time.

According to further embodiments of the invention, the method further comprises coating at least a part of the laminated body structure with an electrically insulating material prior to winding the coil around the intermediate portion. The coating may be provided by spraying the electrically insulating material onto the surface of the laminated body structure or in any other suitable way. The coating may prevent electrical contact between the coil and the laminated body structure.

According to further embodiments of the invention, the method further comprises (a) mounting the laminated body structure in a winding machine prior to winding the coil around the intermediate portion, and (b) releasing the laminated body structure from the winding machine after winding the coil around the intermediate portion. The laminated body structure is mounted in the winding machine by means of a fastening member which can also be used to fasten the pole unit to a stator support structure.

According to a sixth aspect of the invention, there is provided a method of assembling a stator assembly for a wind turbine generator, the method comprising (a) providing a stator support structure, (b) providing a plurality of pole units according to the first aspect or any of the above embodiments thereof, and (c) arranging the pole units along a circumference of the stator support structure.

The sixth aspect of the invention is essentially based on the same idea as the second aspect described above.

It is noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless otherwise indicated, in addition to any combination of features belonging to one type of subject matter also any combination of features relating to different subject matters, in particular to combinations of features of the method type claims and features of the apparatus type claims, is part of the disclosure of this document.

### BRIEF DESCRIPTION

Some of the embodiments will be described in detail, with reference to the following figures, wherein like designations denote like members, wherein:

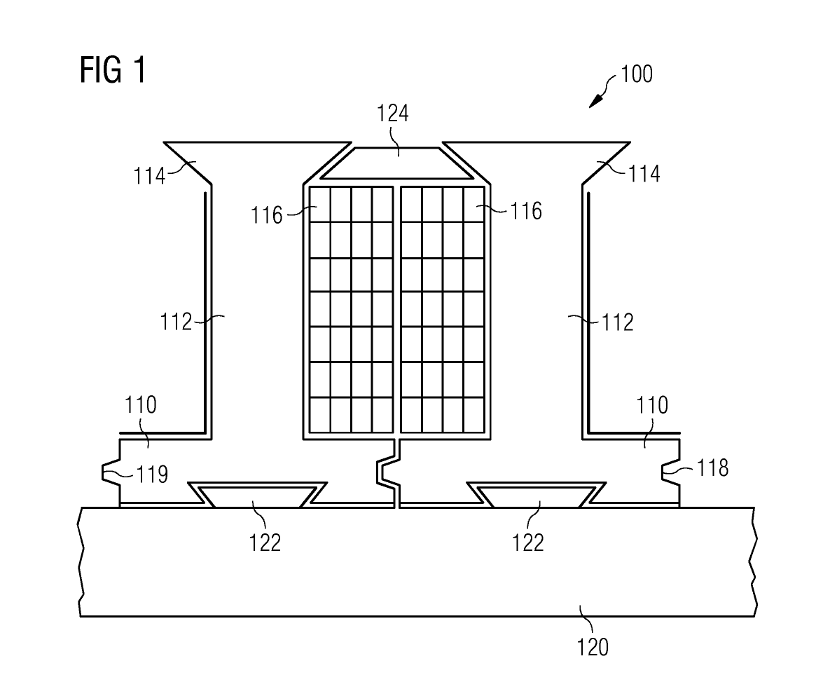

FIG. 1 shows a schematic end view of an embodiment of a part of a stator;

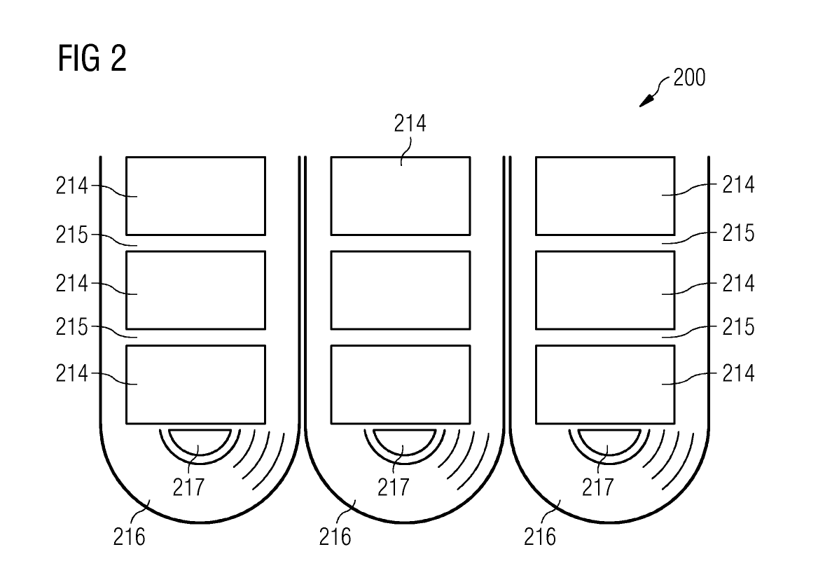

FIG. 2 shows a top view of an embodiment of a part of a stator assembly; and

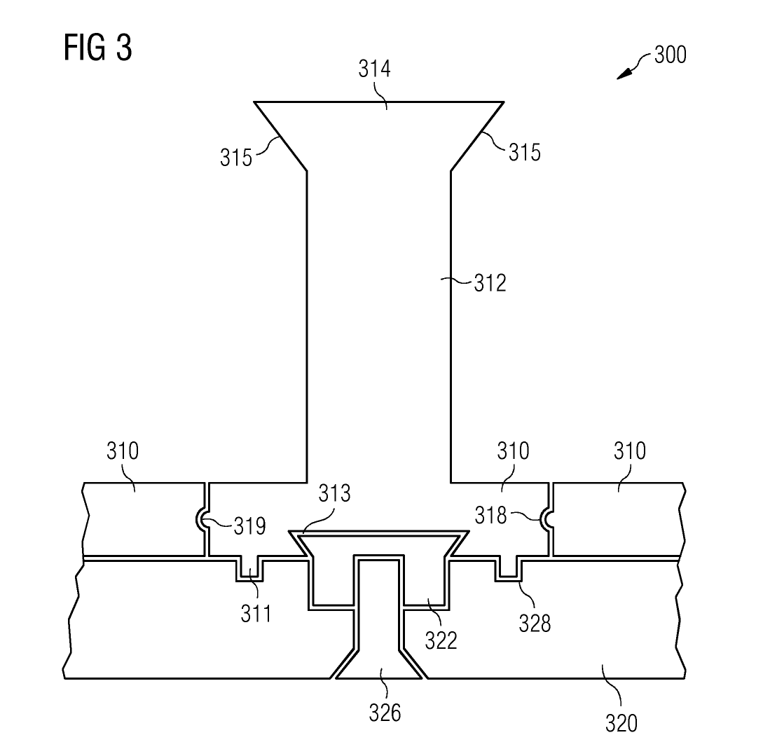

FIG. 3 shows a further schematic end view of an embodiment of a part of a stator assembly.

### DETAILED DESCRIPTION

The illustration in the drawing is schematic. It is noted that in different figures, similar or identical elements are provided with the same reference numerals or with reference numerals which differ only within the first digit.

FIG. 1 shows a schematic end view of a part of a stator assembly 100 according to an embodiment of the present invention. More specifically, the drawing shows two neighboring pole units arranged on a stator support structure 120. Each pole unit comprises a laminated body structure and a coil 116. The laminated body structure comprises a base portion 110, an intermediate portion 112 and a top portion 114 and is essentially shaped as an upside-down T-structure. In other words, the base portion 110 is relatively broad and flat while the intermediate portion 112 is relatively long and less broad. The top portion 114 is short in comparison to the intermediate portion 112 and has an increasing cross-section towards the top of the structure. In other words, the sides of the top portion are slanted. This shape provides an advantageous reduction in the capacitive coupling between coil 116 and a rotor (not shown) arranged to rotate relative to the stator assembly 100.

The base portion 110 comprises a side recess 118 and a side protrusion 119 on opposite sides for engaging with corresponding recesses and protrusion of neighboring pole units in order to facilitate positioning and to improve stability of the stator assembly 100. Each pole unit is fastened to the stator support structure 120 via a fastening member 122 which fits into a recess in the lower surface of the base portion 110. The fastening to the stator support structure 120 will be described in greater detail below in connection with FIG. 3.

The laminated body structure is made from a plurality of thin metal sheets that are stamped to have suitable shapes and which are glued together to form a solid magnetically conducting body structure. The coil 116 consists of several layers of flat copper wire material which is wound or bent around the intermediate portion 112 of the complete laminated body structure. It should be noted that FIG. 1 only shows half of the coil of each of the two pole units. Further, it should be noted that the fastening member 122 is also used to mount the laminated body structure in a winding machine when the coil is wound or bent around the structure. The surface of the laminated body structure, in particular the surface of the intermediate portion 112, is covered with an electrically insulating material in order to isolate the laminated body structure from the coil 116. Similarly, the outer surface of the coil 116 is covered with an electrically insulating material to isolate it from neighboring coils etc. The coils 116 are kept in place by wedge 124 which is made from a composite material and designed to fit snuggly on top of the coils 116 and between opposing sides of the top portions 114 of neighboring pole units.

FIG. 2 shows a top view of a part of a stator assembly 200 according to an embodiment of the present invention. More specifically, FIG. 2 shows a top view of three neighboring pole units of the stator assembly 200. As in FIG. 1, each pole unit comprises a laminated body structure around which a coil 216 is wound. The laminated body structure comprises air ducts 215 extending through the top portion 214 and at least down through the intermediate portion (not shown) in order to allow a flow of cooling air to cool the coil 216 and laminated body structure during operation. Wedges 217 are arranged at the outside end of the laminated body structure to protect the coil, i.e. to prevent the coil from being bent too strongly. It is noted that the air ducts 215 may be omitted in other embodiments, which rely on other means for cooling, such as a cooling liquid.

FIG. 3 shows a further schematic end view of a part of a stator assembly 300 according to an embodiment of the present invention. Like in FIG. 1, several pole units are arranged next to each other and fastened to stator support structure 320. Each pole unit comprises a laminated body structure having a base portion 310, intermediate portion 312 and top portion 314, and a coil (not shown) wound around the intermediate portion 312. The sides 315 of the top portion 314 are slanted such that the width of the top portion 314 increases in the upwards direction. Corresponding side recesses 318 and side protrusions 319 of neighboring pole units engage with each other as described above.

The lower surface of the base portion comprises protrusions 311 and a recess 313. The recess extends along a central part of the lower surface of the base portion, i.e. directly opposite to the intermediate portion 312. The bottom of the recess 313 is substantially flat and parallel with the upper and lower surfaces of the base portion 310. The side walls of the recess are slanted such that the width of the recess increases towards the bottom of the recess. Thereby, the fastening member 322, which has correspondingly slanted upper side walls, can be slid into the recess 313 and pulled down towards the stator support structure 320 by tightening screw 326 which extends through a hole in the stator support structure 320 and into a lower part of the fastening member 322. It should be noted that more than one screw 326 can be used. The protrusions 311 extend on both sides of the recess 313 and serve to facilitate positioning of the pole unit correctly on the stator support structure by fitting the protrusions 311 into corresponding recesses 328 in the upper surface of the stator support member.

It should be noted that a similar mechanism, i.e. the fastening member 322 and screw 326 can be used during production of each single pole unit to fixate the laminated body structure on a surface of a winding machine, said surface having a similar structure as the surface of the shown stator support structure 320. When the laminated body structure is fixed in the winding machine, the coil is wound directly around the intermediate portion 312 of the laminated body structure. Thereby, the pole units can be produced in a simple and efficient manner without the need for fitting a pre-wound coil around a part of the body structure and then subsequently finalizing the top portion of the body structure to provide the desired reduction of noise and the capacitance between coil and rotor. Instead, the complete body structure is produced as a single integral laminated structure, and after coating with insulating material and mounting in the winding machine, the coil is wound directly around the body structure and covered with insulation material already mounted on the pole unit. Finally the wound pole unit is impregnated with electrically insulating resin and hardened at an increased temperature. Apart from the facilitated production, the pole units are relatively compact units that can be packed and transported efficiently in comparison to e.g. huge curved stator segments with e.g. 18 poles.

It is noted that the term “comprising” does not exclude other elements or steps and the use of the articles “a” or “an” does not exclude a plurality. Also elements described in association with different embodiments may be combined.

1. A pole unit for a stator assembly a wind turbine generator, the pole unit comprising:
a laminated body structure comprising a base portion, an intermediate portion, and a top portion; and
a coil wound around the intermediate portion;
wherein the intermediate portion extends from at least a part of an upper surface of the base portion;
wherein the top portion extends from an end of the intermediate portion that is opposite to the base portion and has an increasing cross-section in a direction away from the intermediate portion; and
wherein the laminated body structure comprises an air duct configured to allow a flow of cooling air.

2. The pole unit according to claim 1, wherein the base portion has a substantially flat rectangular shape, wherein the intermediate portion has a substantially rectangular cross-sectional shape, and wherein a cross-sectional area of the intermediate portion is smaller than an area of the base portion.

3. The pole unit according to claim 1, wherein the base portion comprises a recess, the recess being formed in a lower surface of the base portion.

4. The pole unit according to claim 1, wherein the base portion comprises at least one protrusion, the at least one protrusion being formed on a lower surface of the base portion.

5. The pole unit according to claim 3, wherein the recess is configured to engage with a fastening member, and/or wherein an at least one protrusion is configured to engage with a corresponding recess in a support structure.

6. The pole unit according to claim 1, wherein the base portion comprises a side protrusion and a side recess, the side protrusion and the side recess being formed in opposing side surfaces of the base portion.

7. The pole unit according to claim 1, wherein the coil comprises a flat, electrically conductive wire material.

8. The pole unit according to claim 1, further comprising:
a first wedge configured to fit snuggly on top of the coil and to keep the coil in place; and
a second wedge arranged at an outside end of the laminated body structure to protect the coil.

9. A stator assembly for a wind turbine generator, the stator assembly comprising:
a stator support structure; and
a plurality of pole units according to claim 1,
wherein the plurality of pole units are arranged along a circumference of the stator support structure.

10. A wind turbine generator comprising a stator assembly according claim 9.

11. A wind turbine comprising a wind turbine generator according to claim 10.

12. A method of manufacturing a pole unit for a stator assembly of a wind turbine generator, the method comprising:
stamping and gluing a plurality of layers of sheet metal, thereby forming a laminated body structure comprising a base portion, an intermediate portion, and a top portion, wherein the intermediate portion extends from at least a part of an upper surface of the base portion, wherein the top portion extends from an end of the intermediate portion that is opposite to the base portion and has an increasing cross-section in a direction away from the intermediate portion, and wherein an air duct is formed in the laminated body structure to allow a flow of cooling air; and
winding a coil around the intermediate portion.

13. The method according to claim 12, further comprising:
coating at least a part of the laminated body structure with an electrically insulating material prior to winding the coil around the intermediate portion.

14. The method according to claim 12, further comprising
mounting the laminated body structure in a winding machine prior to winding the coil around the intermediate portion; and
releasing the laminated body structure from the winding machine after winding the coil around the intermediate portion.

15. A method of assembling a stator assembly for a wind turbine generator, the method comprising:
providing a stator support structure;
providing a plurality of pole units according to claim 1; and
arranging the plurality of pole units along a circumference of the stator support structure.
